(19) United States
(12) Patent Application Publication
(10) Pub. No.: US 2019/0325716 A1
(43) Pub. Date: Oct. 24, 2019

(54) HAPTIC-ENABLED WEARABLE DEVICE

(71) Applicant: Immersion Corporation, San Jose, CA (US)

(72) Inventors: Vahid KHOSHKAVA, Laval (CA); Jamal SABOUNE, Montreal (CA); Juan Manuel CRUZ-HERNANDEZ, Westmount (CA); Mansoor ALGHOONEH, Richmond Hill (CA)

(21) Appl. No.: 16/389,590

(22) Filed: Apr. 19, 2019

Related U.S. Application Data
(60) Provisional application No. 62/660,752, filed on Apr. 20, 2018.

(51) Int. Cl. G08B 6/00; G06F 3/01

(52) U.S. Cl. CPC G08B 6/00; G06F 3/014

(57) ABSTRACT

Systems, devices, methods, non-transitory computer readable mediums for generating one or more haptic effects are provided. For example, a device includes a substrate including a plurality of haptic regions, and a plurality of haptic output devices, each haptic output device being coupled to a respective haptic region, and each haptic output device being configured to generate a haptic effect in response to receiving a haptic drive signal, as described herein. The haptic effect is perceptible to a user within one cycle of the haptic drive signal.

### PRIORITY APPLICATION

This application claims priority to U.S. Provisional Application Ser. No. 62/660,752, filed on Apr. 20, 2018, the contents of which are incorporated herein by reference in their entirety.

### TECHNICAL FIELD

The embodiments are generally directed to electronic devices, and more particularly, to haptic-enabled electronic devices.

### BACKGROUND

Electronic devices, such as mobile devices, personal computers, home video game consoles, handheld video game consoles, automobile consoles, etc., typically use visual and auditory cues to provide feedback to a user. In some electronic devices, kinesthetic feedback and/or tactile feedback may be provided to the user. Kinesthetic feedback is known as “kinesthetic haptic feedback” or “kinesthetic haptic effects,” and may include, for example, active and resistive force feedback. Tactile feedback is known as “tactile haptic feedback” or “tactile haptic effects,” and may include, for example, vibration, texture, temperature variation, etc. In general, kinesthetic and tactile feedback are collectively known as “haptic feedback” or “haptic effects.” Haptic effects provide cues that enhance a user's interaction with an electronic device, from augmenting simple alerts to specific events to creating a greater sensory immersion for the user within an augmented, simulated or virtual environment, such as, for example, a gaming environment.

In general, an application executed by the operating system (“OS”) or real time operating system (“RTOS”) of the electronic device sends commands to one or more haptic actuators to generate haptic effects. For example, when a user interacts with a touchscreen of the electronic device, or a touchscreen of a separate device coupled to the electronic device, such as, for example, a video game controller, etc., the application sends commands to the haptic actuators to produce haptic effects that are perceived by the user.

### SUMMARY OF THE INVENTION

Embodiments of the present invention are directed toward electronic devices configured to produce haptic effects that substantially improve upon the related art as described herein. Features and advantages of the embodiments are set forth in the description which follows, or will be apparent from the description, or may be learned by practice of the invention. Systems, devices, methods, and non-transitory computer readable mediums for generating one or more haptic effects are provided.

For example, a wearable device includes a substrate including a plurality of haptic regions, and a plurality of haptic output devices, each haptic output device being coupled to a respective haptic region, and each haptic output device being configured to generate a haptic effect in response to receiving a haptic drive signal, as described herein.

In another example, a method for rendering a haptic effect on a wearable device includes receiving, at one or more of a plurality of haptic output devices, a haptic effect signal configured to generate the haptic effect, each of the haptic output devices being coupled to a respective haptic region of a substrate that forms the wearable device, and generating the haptic effect in response to the haptic drive signal.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 illustrates a haptic-enabled wearable device according to an example embodiment of the present invention.

FIG. 2 illustrates a force diagram for the haptic-enabled wearable device according to an example embodiment of the present invention.

FIG. 3 illustrates a haptic-enabled wearable device according to another example embodiment of the present invention.

FIGS. 4A and 4B illustrate haptic-enabled wearable devices according to yet other example embodiments of the present invention.

FIG. 5 illustrates a graph of measured acceleration at varying frequencies of the haptic-enabled wearable device according to an example embodiment of the present invention.

FIG. 6 illustrates a graph of measured acceleration versus time in response to a drive signal of the haptic-enabled wearable device according to an example embodiment of the present invention.

FIG. 7 illustrates a graph of current consumption versus time in response to a drive signal of the haptic-enabled wearable device according to an example embodiment of the present invention.

FIG. 8 is a block diagram of a haptic-enabled system according to an example embodiment of the present invention.

### DETAILED DESCRIPTION

Reference will now be made in detail to embodiments, examples of which are illustrated by the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, and circuits have not been described in detail so as not to unnecessarily obscure aspects of the embodiments. Wherever possible, like reference numbers will be used for like elements.

Embodiments of haptically-enabled substrates described herein may be part of a variety of electronic device types and/or may be communicatively coupled to a variety of electronic devices, including a wearable device, augmented or virtual reality device, smart watch, haptically-enabled eyeglasses as well as a portable communication device, mobile phone, tablet, game console, etc. The user interfaces associated with the haptically-enabled substrate may include a display, touch screen, gyroscopic or other acceleration device, and/or other input/output devices.

The embodiments described herein are generally directed to a haptic-enabled wearable device configured to provide multi-frequency or kinesthetic haptic feedback. Such wearable devices include a structure, such as a curved, semi-curved, or C-shape structure, configured to amplify the force and displacement of a smart material actuator, such as piezo-ceramic actuator. Other haptic actuators may be used as well, including, for example, electroactive polymers (e.g., dielectric elastomer, polyvinylidene fluoride (PVDF) homo- or co- or ter-polymer), shape memory alloys (SMA), etc. In some embodiments, a haptic-enabled wearable device includes a substrate (e.g., a surface, layer, body, structure, etc.) that is associated with or coupled to (e.g., adhered to, adjacent to, affixed to, attached to, bonded to, connected to, directly or indirectly coupled to, physically coupled to, functionally coupled to, embedded to, joined to, linked to, near to, spaced apart from, etc.) one or more haptic output devices (e.g., an actuator). At one or more portions of the substrate, respective haptic actuators are coupled to the substrate, and configured to generate one or more haptic effects in response to receiving a haptic effect signal. In a typical configuration, the haptic actuator is a Macro Fiber Composite (MFC) actuator.

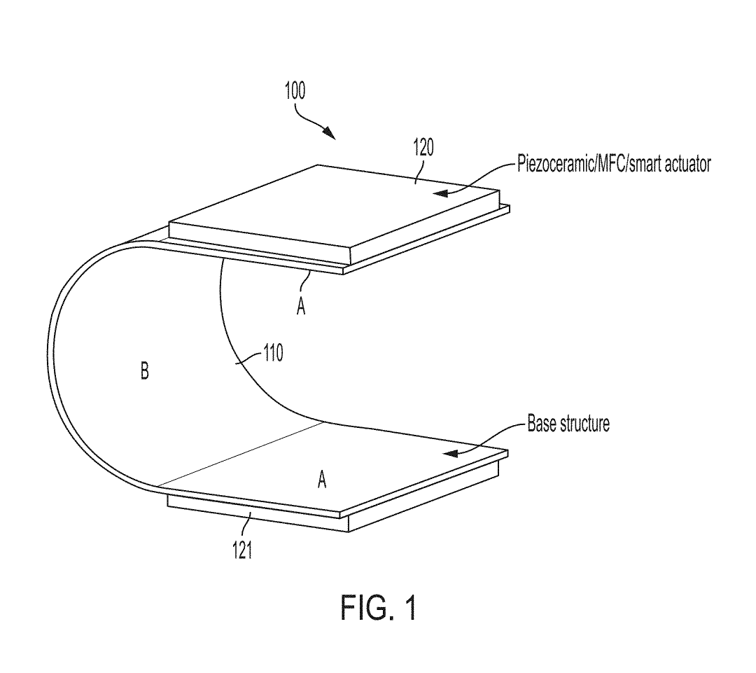

FIG. 1 illustrates a haptic-enabled wearable device 100 according to an example embodiment of the present invention. As shown in FIG. 1, haptic-enabled wearable device 100 includes a substrate 110 (e.g., a surface, layer, body, or structure) and haptic actuators 120, 121. Substrate 110 may include a plurality of sections, such as sections “A” and “B” as depicted in FIG. 1.

Substrate 110 may be configured as a bracelet or any other wearable device. Substrate 110 may be comprised of one or more of a variety of materials and may be comprised of a single or multi-layer structure. Substrate 110 may include a three-dimensional (3D) printed wearable layer, a foam layer, a protective or insulating layer (e.g., Kapton tape layer), an epoxy layer, a thin metallic sheet, a thin composite sheet, a Plexiglas sheet, a carbon fiber sheet, and/or the like. As substrate 110 is adapted to form a wearable device, it is generally formed from a flexible or elastic material. Additionally, or alternatively, substrate 110 may have a curved, semi-curved, or C-shaped structure, as shown in FIG. 1.

Haptic actuators 120, 121 may be coupled to substrate 110. For example, embodiments include a curved, semi-curved, or C-shaped substrate structure with epoxy-bonded MFCs disposed at two locations. In the various configurations, haptic actuators 120, 121 may be coupled to inner and/or outer sides of substrate 110. Alternatively, in some embodiments, haptic actuators 120, 121 may be embedded within substrate 110. Additionally, or alternatively, haptic actuators 120, 121 may be driven jointly (i.e., driven by the same signal and same circuit/amplifier) or driven independently (i.e., driven by different signals and different circuits/amplifiers).

Haptic actuators 120, 121 may include piezo-ceramic, smart material, and/or MFC actuators. Generally, an MFC actuator is formed by depositing (e.g., inserting, layering, sandwiching, etc.) rectangular, ribbon-shaped piezo-ceramic rods between layers of adhesive, electrodes and polyimide film. The electrodes are coupled to the film in an inter-digitated pattern in order to transfer the applied voltage directly to, and from, the piezo-ceramic rods. An MFC actuator may be coupled to substrate 110 as a thin, surface-conformable sheet.

In certain embodiments, the thickness of the MFC actuator may be approximately 0.5 mm. Alternatively, the thickness of the MFC actuator may be less than 0.5 mm, such as, for example, 10 μm to 100 μm, or more than 0.5 mm, such as, for example, about 2 to 3 mm, about 1 to 2 mm, or less than 1 mm. In certain embodiments, haptic actuators 120, 121 may include the “MFC M5628 P1” from Smart Material Corp.

The mechanical properties of haptic-enabled wearable device 100, its dimensions, as well as the type, number, and arrangement of the haptic output devices, may be varied to produce a wide range of haptic outputs and effects. For example, depending on the frequency of the haptic effects, MFC actuators may be configured to render vibro-tactile or kinesthetic like effects (e.g., a deformation at very low frequencies).

In some embodiments, substrate 110 may be integrated into, or form a part of, a display or touchscreen of an electronic device. Similarly, substrate 110 may be integrated into, or form a part of, or a display or touchscreen of a separate device coupled to the electronic device, such as, for example, a video game controller, etc.

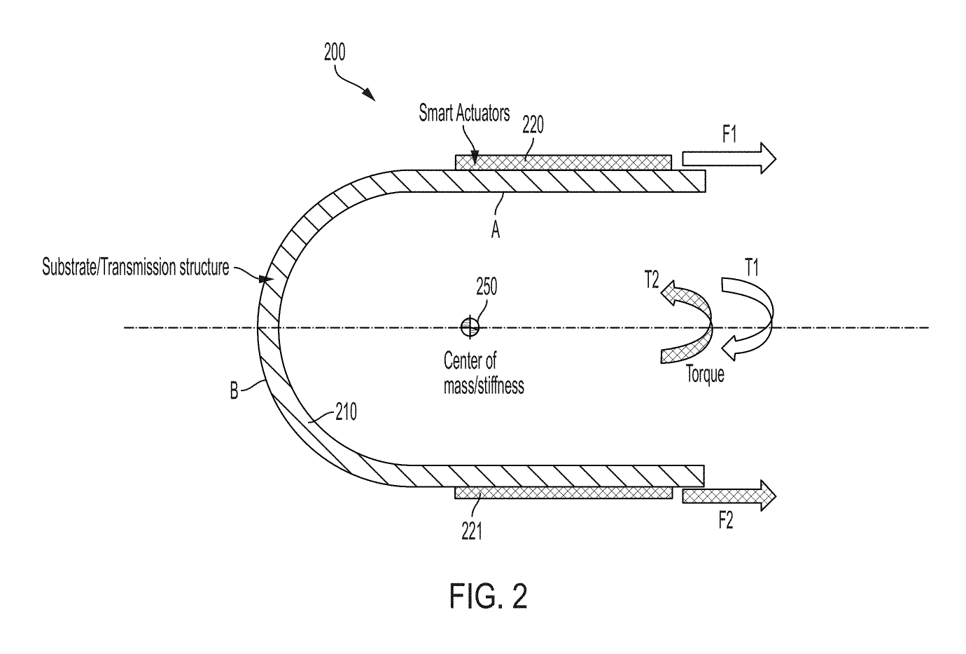

FIG. 2 illustrates a force diagram for the haptic-enabled wearable device 200 according to an example embodiment of the present invention. As shown in FIG. 2, haptic-enabled wearable device 200 includes a substrate 210 and haptic actuators 220, 221.

In some embodiments, haptic actuators 220, 221 generate forces (e.g., “F1” or “F2”) that result in a torque (e.g., T1“” or “T2”) around a reference point such as center of mass 250 of haptic-enabled wearable device 200. Haptic actuators 220, 221 contract or expand, and when coupled to substrate 210 generate torque T1, T2. Element 250 also may designate the center of stiffness or rigidity. By increasing torque around the curved section “B”, the displacement and force in sections “A” are increased. Similarly, by decreasing the torque around the curved section “B”, the displacement and force in sections “A” are decreased. Additionally, top and bottom sections of substrate 210 (e.g., straight, flat, linear, or haptic sections labeled as “A” in FIG. 1) are flexible and are configured to close or open depending on the type of the MFC used (e.g., expansion or contraction MFC type).

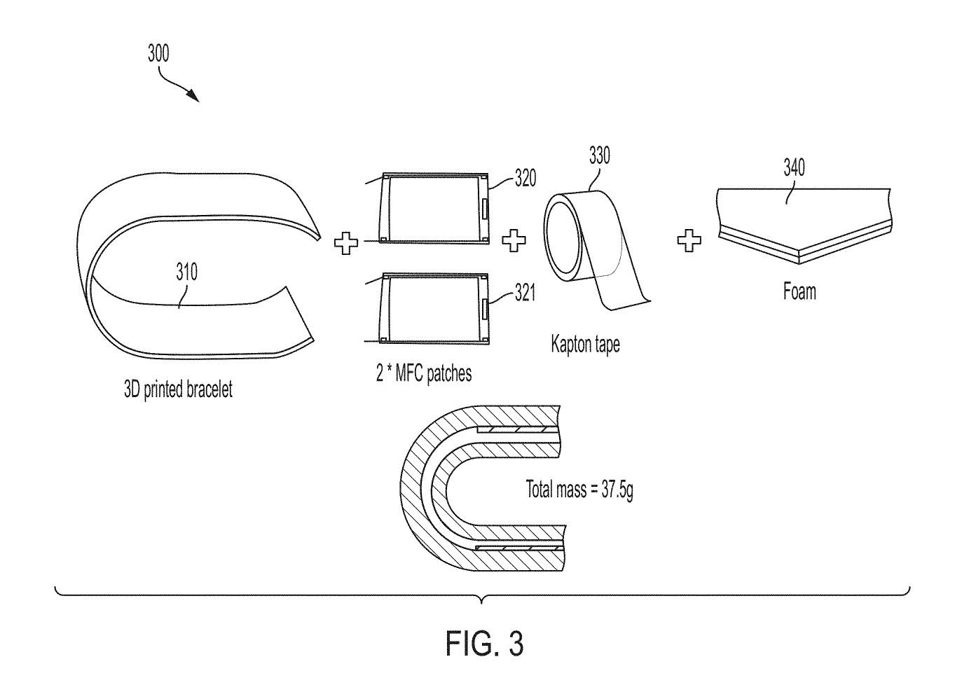

FIG. 3 illustrates a haptic-enabled wearable device 300 according to another example embodiment of the present invention. As shown in FIG. 3, haptic-enabled wearable device 300 includes a substrate 310 and haptic actuators 320, 321.

In this example configuration, haptic actuators 320, 321 may be coupled to substrate 310 using an epoxy or other binding agent. An optional protective or insulating layer, such as Kapton tape 330 or the like, also may be applied to haptic actuators 320, 321. Additionally, the haptic-enabled wearable device 300 may include a foam layer 340 to ensure user comfort.

Wearable device 300 may be configured to be lightweight. Wearable device may have a weight of approximately 37.5 g, for example. The weight of wearable device 300 may vary its response to haptic drive signals (e.g., frequency and magnitude of the vibration). By using lightweight materials for wearable device 300, the lighter the mass that haptic actuators 320, 321 are moving. A typical user may perceive haptic feedback having a force as low as 30 mN or 40 mN, and depending on the weight of wearable device 300, the output acceleration may vary according to the mass associated with the haptic actuator to produce a force perceptible to a user. For example, and as force is a product of mass and acceleration, a haptic actuator producing a peak to peak acceleration value produces a lower force when coupled to a relatively lighter weight material (i.e., less mass) as compared to producing a higher force when coupled to a relatively heavier weight material (i.e., still light weight, but relatively more mass).

In addition to the versatility provided by the use of lightweight materials, mechanical optimizations can be employed to increase haptic performance. The stiffness of the substrate 310, which is a function of the mechanical properties of the substrate and the geometry of the structure (e.g., C-shape, Oval, etc.) may be configured to increase or decrease the torque, force, and/or displacement. For example, a haptic actuator producing a peak to peak acceleration value produces less displacement and force for a more stiff (or rigid) material as compared to a less stiff material. Similarly, a haptic actuator producing a peak to peak acceleration value produces less torque for a more stiff (or rigid) material as compared to a less stiff material. Additionally, the actuator type (e.g., piezo-ceramics, electro-active polymers (“EAP”), etc.) and the actuator design (e.g., unimorph, bimorph, stacking, etc.) also may be selected or otherwise configured to provide the desired haptic feedback.

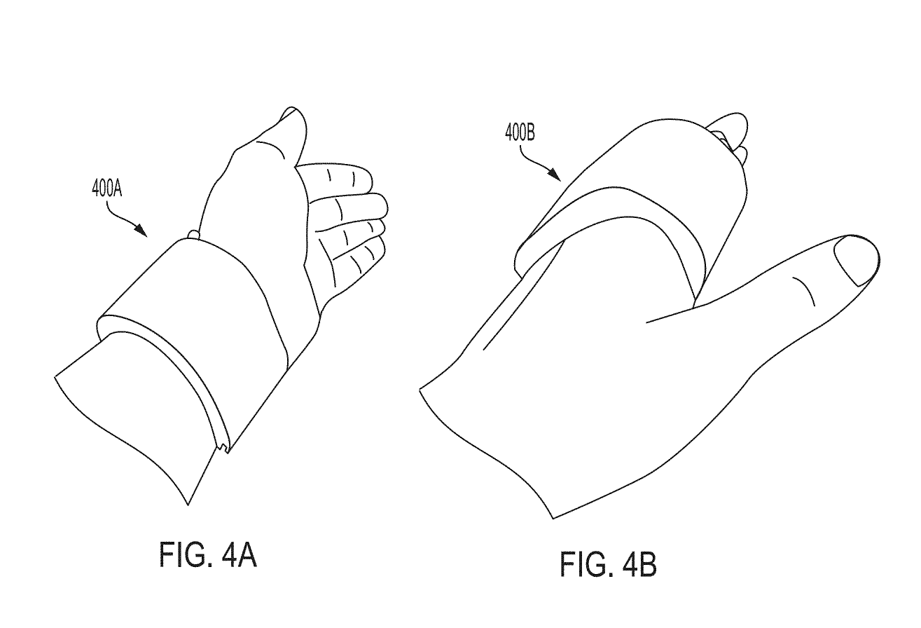

FIGS. 4A and 4B illustrate haptic-enabled wearable devices 400A, 400B according to yet other example embodiments of the present invention.

Each of FIGS. 4A and 4B illustrate actual working implementations of the embodiments. Haptic-enabled wearable devices 400A, 400B may be worn around the wrist as a cuff, as shown in FIG. 4A, or around the palm, as shown in FIG. 4B. Alternatively, or additionally, the haptic-enabled wearable devices 400A, 400B may be adapted to fit any body part (e.g., ankles, feet, forearms, head, neck, etc.). For example, haptic-enabled wearable devices 400A, 400B may be configured as a ring to provide haptic feedback to fingers or toes. In another example, haptic-enabled wearable devices 400A, 400B may be configured as a headband or necklace to provide haptic feedback to head or neck.

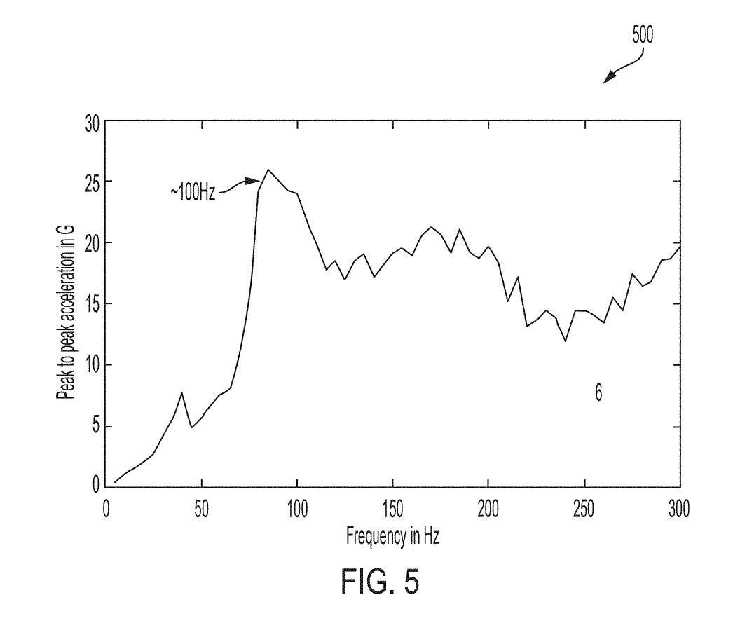

FIG. 5 illustrates a graph 500 of measured peak to peak acceleration at varying frequencies of the haptic-enabled wearable device according to an example embodiment of the present invention. In the example graph 500, acceleration is shown for an example MFC bracelet, such as the example haptic-enabled wearable devices 100, 200, 300, 400A, 400B shown in FIGS. 1, 2, 3, 4A, and 4B, respectively. Here, graph 500 illustrates acceleration for a bracelet driven by a frequency sweep in the range of 5 to 300 Hz in response to ten pulses. At frequencies above approximately 70 Hz, the example MFC bracelet achieves high acceleration signals (e.g., more than 10 G peak to peak). In addition, peak to peak acceleration above 25 G is achieved at approximately 100 Hz.

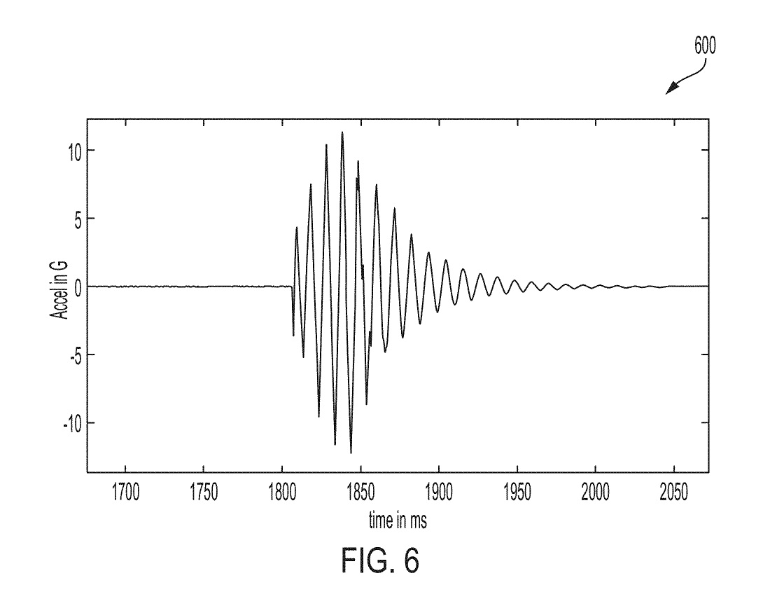

FIG. 6 illustrates a graph 600 of measured acceleration versus time in response to a drive signal of the haptic-enabled wearable device according to an example embodiment of the present invention. In the example graph 600, acceleration is shown for an example MFC bracelet, such as the example haptic-enabled wearable devices 100, 200, 300, 400A, 400B shown in FIGS. 1, 2, 3, 4A, and 4B, respectively. Here, graph 600 illustrates the acceleration response to four pulses at 100 Hz. As shown, peak to peak acceleration greater than 10 G is achieved within three of the four pulses at 100 Hz.

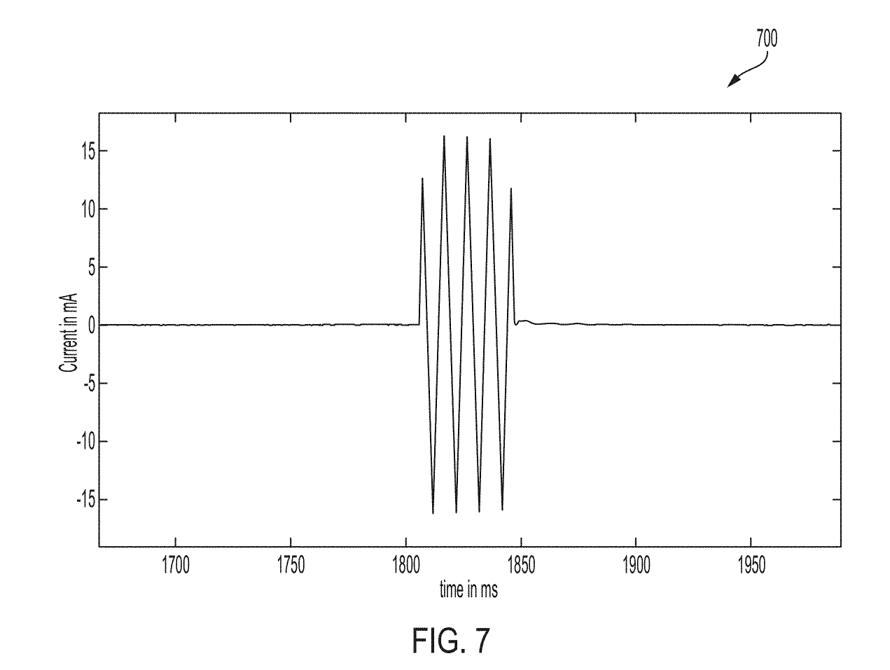

FIG. 7 illustrates a graph of current consumption versus time in response to a drive signal of the haptic-enabled wearable device according to an example embodiment of the present invention. In the example graph 700, current consumption is shown for an example MFC bracelet, such as the example haptic-enabled wearable devices 100, 200, 300, 400A, 400B shown in FIGS. 1, 2, 3, 4A, and 4B, respectively. Here, the graph illustrates the current consumption in response to four pulses at 100 Hz. Current consumption in response to four pulses at 100 Hz is low and between approximately 12-17 mA, as shown.

Accordingly, the haptic actuator/systems described herein provide fast response times and achieves high acceleration haptic effects. As shown in FIGS. 5, 6, and 7, the response time of the haptic actuator/system is fast (e.g., less than 10 ms). Furthermore, the haptic actuator/system achieves high acceleration signals (e.g., more than 10 G peak to peak) in one cycle (i.e., one pulse) as compared to conventional mobile devices that take several cycles to reach 2 G or 3 G. As a result, perceptible haptic feedback (e.g., having a force of at least 30 mN or 40 mN, or having a force within a range within a range of 30 mN to 40 mN) may be rendered to a user within one cycle.

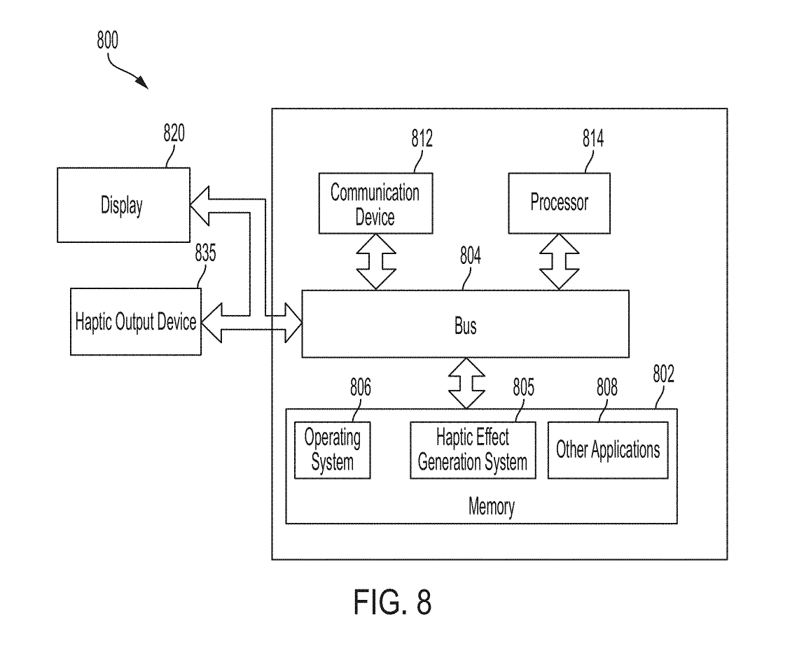

FIG. 8 is a block diagram of a haptic-enabled system 800 according to an example embodiment of the present invention.

Although shown as a single system, the functionality of haptic-enabled system 800 can be implemented as a distributed system. Haptic-enabled system 800 includes a bus 804 or other communication mechanism for communicating information, and a processor 814 coupled to bus 804 for processing information. Processor 814 can be any type of general or specific purpose processor. Haptic-enabled system 800 further includes a memory 802 for storing information and instructions to be executed by processor 814. Memory 802 can be comprised of any combination of random access memory (“RAM”), read only memory (“ROM”), flash memory, solid state memory, static storage such as a magnetic or optical disk, or any other type of non-transitory computer-readable medium.

A non-transitory computer-readable medium can be any available medium that can be accessed by processor 814, and can include both a volatile and nonvolatile medium, a removable and non-removable medium, and a storage medium. A storage medium can include RAM, flash memory, ROM, solid state memory, erasable programmable read-only memory (“EPROM”), electrically erasable programmable read-only memory (“EEPROM”), registers, hard disk, a removable disk, a compact disk read-only memory (“CD-ROM”), or any other form of a storage medium known in the art.

According to an example embodiment, memory 802 stores software modules that provide functionality when executed by processor 814. The software modules include an operating system 806 that provides operating system functionality for haptic-enabled system 800, as well as the rest of the haptic-enabled system 800. The software modules can also include haptic effect generation module 805 that generates haptic effect signals. The software modules further include other applications 808, such as, a video-to-haptic conversion algorithm.

Haptic-enabled system 800 can further include a communication device 812 (e.g., a network interface card) that provides wireless network communication for infrared, radio, Wi-Fi, or cellular network communications. Alternatively, communication device 812 can provide a wired network connection (e.g., a cable/Ethernet/fiber-optic connection, or a modem).

Processor 814 is further coupled via bus 804 to a visual display 820 for displaying a graphical representation or a user interface to an end-user. Visual display 820 can be a touch-sensitive input device (i.e., a touch screen) configured to send and receive signals from processor 814, and can be a multi-touch touch screen.

Haptic-enabled system 800 also includes haptic wearable device 835 (such as elements 100, 200, 300, 400A, 400B described above). Processor 814 transmits a haptic signal associated with a haptic effect to haptic system 100, which in turn outputs kinesthetic and/or tactile haptic effects using one or more haptic actuators 120. In many embodiments, haptic wearable device 835 may be integrated into display 820.

The haptic-enabled wearable devices described herein may be configured to render haptic effects for gaming, augmented reality (AR) or virtual reality (VR) interactions, and/or haptic-augmented audiovisual (AV) media. Haptic-enabled wearable devices may be configured to interface with mobile devices, AR/VR systems, laptops, or any other electronic systems with a haptic display feature. Additionally, or alternatively, the haptic-enabled wearable devices may be configured as input devices by including pressure or force sensing patches (e.g., MFC patches) on the substrate of the structure such that the user can control the gameplay or the VR/AR environment (i.e., virtual buttons). In some embodiments, Inertial Measurement Unit (“IMUs”) may be included such that specific movements of the device/body part are recognized as gesture inputs to the underlying system. For example, consider a user playing a shooting game inside a VR environment. The user has a haptic-enabled wearable device resting on his/her wrist and uses it as an input and as a haptic display device. Here, in order to shoot a gun in the game, the user just moves his/her forearm in a movement mimicking the rifle shooting and receives the related haptic effect on the wearable device as well. In some further embodiments, other types of sensors, such as biometric or environmental sensors, may be used. Example biometric sensors include sensors for heart rate, blood pressure, insulin, hydration, etc. Example environmental sensors include sensors for temperature, humidity, light, wind, etc. Sensors can be used to generate haptic effects or to influence the rendering of a simulated environment.

In some embodiments, the haptic-enabled wearable devices may include other types of haptic capabilities, such as thermal patches (i.e., Peltier effects). Additionally, or alternatively, a plurality of haptic-enabled wearable devices can operate in parallel, being used on different body parts.

Thus, a new interaction device for AR/VR/gaming using smart material actuation is provided. This unobtrusive and lightweight device has a slim profile, and can deliver vibrotactile haptic effects at different frequencies and magnitudes, as well as kinesthetic effects through shape deformation. The haptic-enabled wearable devices described herein are slim, light-weight, and deliver a multitude of haptic effect types as compared to mono-dimensional electromechanical devices.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. A wearable haptic device, comprising:
a substrate including a plurality of haptic regions, the substrate having a C-shape; and
a plurality of haptic output devices, each haptic output device being coupled to a respective haptic region, and each haptic output device being configured to generate a haptic effect in response to receiving a haptic drive signal, and each haptic output device being configured to render the haptic effect that is perceptible to a user within one cycle of the haptic drive signal.

2. The wearable haptic device according to claim 1, wherein the plurality of haptic output devices include a Macro Fiber Composite (MFC) actuator.

3. The wearable haptic device according to claim 2, wherein a thickness of the MFC actuator is between 0.1 mm to 0.5 mm.

4. The wearable haptic device according to claim 1, wherein the substrate includes one or more of the following: a three-dimensional (3D) printed wearable layer, a foam layer, a protective or insulating layer, an epoxy layer, a thin metallic sheet, a thin composite sheet, a Plexiglas sheet, and a carbon fiber sheet.

5. The wearable haptic device according to claim 1, wherein the plurality of haptic output devices are epoxy-bonded to the substrate.

6. The wearable haptic device according to claim 1, wherein the plurality of haptic output devices are coupled to an inner or outer surface of the substrate.

7. The wearable haptic device according to claim 1, wherein the plurality of haptic output devices are embedded within the substrate.

8. The wearable haptic device according to claim 1, wherein at least one of the plurality of haptic output devices is integrated into a touchscreen of the wearable haptic device.

9. The wearable haptic device according to claim 1 wherein the substrate is integrated into a display.

10. The wearable haptic device according to claim 1, wherein the plurality of haptic output devices includes one of a piezo-ceramic actuator, an electroactive polymer, and a shape memory alloy (SMA).

11. The wearable haptic device according to claim 1, wherein the plurality of haptic output devices generate one or more forces that result in a torque around a center of mass of the wearable haptic device.

12. The wearable haptic device according to claim 1, wherein the plurality of haptic output devices generate one or more forces that result in a torque around a center of stiffness of the wearable haptic device.

13. The wearable haptic device according to claim 1, wherein the wearable haptic device is a ring configured to be worn on a finger of a user.

14. The wearable haptic device according to claim 1, wherein the haptic actuator has a response time less than 10 ms.

15. A method for rendering a haptic effect on a wearable device, the method comprising:
receiving, at one or more of a plurality of haptic output devices, a haptic effect signal configured to generate the haptic effect, each of the haptic output devices being coupled to a respective haptic region of a substrate that forms the wearable device, the substrate having a C-shape; and
generating the haptic effect in response to the haptic drive signal, wherein each of the plurality of haptic output devices is configured to generate the haptic effect that is perceptible to a user within one cycle of the haptic drive signal.

16. The method according to claim 15, wherein the plurality of haptic output devices include a Macro Fiber Composite (MFC) actuator.

17. The method according to claim 15, wherein at least one of the plurality of haptic output devices is integrated into a touchscreen of the wearable haptic device.

18. The method according to claim 15, wherein the wearable haptic device is a ring configured to be worn on a finger of a user.

19. The method according to claim 15, wherein at least one of the plurality of haptic output devices has a response time less than 10 ms.

20. The method according to claim 15, wherein the plurality of haptic output devices includes one of a piezo-ceramic actuator, an electroactive polymer, and a shape memory alloy (SMA).
